(19) United States
(12) Patent Application Publication
(10) Pub. No.: US 2010/0040028 A1
(43) Pub. Date: Feb. 18, 2010

(54) METHOD AND APPARATUS FOR MITIGATION OF PROCEDURES IN A WIRELESS COMMUNICATION SYSTEM

(75) Inventors: Shailesh Maheshwari, San Diego, CA (US); Srividhya Krishnamoorthy, San Diego, CA (US); Arnaud Meylan, Bois-Colombes (FR)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/539,977

(22) Filed: Aug. 12, 2009

Related U.S. Application Data
(60) Provisional application No. 61/088,552, filed on Aug. 13, 2008.

(51) Int. Cl. H04J 3/00

(52) U.S. Cl. 370/336; 370/352

(57) ABSTRACT

The described apparatus and methods may include a controller configured to receive data on a logical channel, determine that a first grant is not available during a first time transmission interval, determine whether to generate at least one of a buffer status report (BSR), a scheduling request (SR), and a random access channel (RACH) procedure based on an amount of the received data, determine that a second grant is available during a second time transmission interval, and transmit the received data during the second time transmission interval without generating the BSR, the SR, and the RACH procedure when the amount of the received data is less than or equal to the size of the grant.

### CLAIM OF PRIORITY UNDER 35 U.S.C. §119

The present Application for Patent claims priority to Provisional Application No. 61/088,552 entitled “MITIGATION OF SCHEDULING REQUEST AND RANDOM ACCESS CHANNEL PROCEDURE IN A LONG TERM EVOLUTION WIRELESS SYSTEM” filed Aug. 13, 2008, and assigned to the assignee hereof and hereby expressly incorporated by reference herein.

### BACKGROUND

1. Field

The present disclosure relates generally to wireless communication systems. More specifically, the present disclosure relates to methods and apparatus for mitigation of procedures in a wireless communication system.

2. Introduction

Wireless communication systems are widely deployed to provide various communication services such as voice, video, packet data, messaging, broadcast, etc. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, orthogonal frequency division multiple access (OFDMA) systems, and single-carrier FDMA (SC-FDMA) systems.

Typically, in LTE systems, semi-persistent scheduling (SPS) is valid only during periodic transmission time intervals (TTI). Unfortunately, arrival of data for transmission from an access terminal to the base station will usually not coincide with the SPS TTI. As such, the arrival of data will most likely result in the triggering of a regular buffer status report (BSR), which in-turn will trigger a scheduling request (SR). If SR is not accepted at the base station, then this will result in the access terminal triggering a spurious random access channel (RACH) procedure, which may be a costly operation from the perspective of the access terminal as well as the base station.

Accordingly, there exists a need in the art for a method and apparatus that mitigate SR and RACH procedures in LTE wireless communication systems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect of the disclosure, a method for wireless communication includes receiving data on a logical channel, determining that a first grant is not available during a first time transmission interval, determining whether to generate at least one of a buffer status report (BSR), a scheduling request (SR), and a random access channel (RACH) procedure based on an amount of the received data, determining that a second grant is available during a second time transmission interval, and transmitting the received data during the second time transmission interval without generating the BSR, the SR, and the RACH procedure when the amount of the received data is less than or equal to the size of the grant.

According to another aspect of the disclosure, a wireless communication apparatus includes a controller configured to receive data on a logical channel, determine that a first grant is not available during a first time transmission interval, determine whether to generate at least one of a buffer status report (BSR), a scheduling request (SR), and a random access channel (RACH) procedure based on an amount of the received data, determine that a second grant is available during a second time transmission interval, and transmit the received data during the second time transmission interval without generating the BSR, the SR, and the RACH procedure when the amount of the received data is less than or equal to the size of the grant.

According to a further aspect of the disclosure, an apparatus includes means for receiving data on a logical channel, means for determining that a first grant is not available during a first time transmission interval, means for determining whether to generate at least one of a buffer status report (BSR), a scheduling request (SR), and a random access channel (RACH) procedure based on an amount of the received data, means for determining that a second grant is available during a second time transmission interval, and means for transmitting the received data during the second time transmission interval without generating the BSR, the SR, and the RACH procedure when the amount of the received data is less than or equal to the size of the grant.

According to yet a further aspect of the disclosure, a computer program product includes a computer-readable medium including code for receiving data on a logical channel, code for determining that a first grant is not available during a first time transmission interval, code for determining whether to generate at least one of a buffer status report (BSR), a scheduling request (SR), and a random access channel (RACH) procedure based on an amount of the received data, code for determining that a second grant is available during a second time transmission interval, and code for transmitting the received data during the second time transmission interval without generating the BSR, the SR, and the RACH procedure when the amount of the received data is less than or equal to the size of the grant.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates aspects of a wireless communication system;

FIG. 2 illustrates an uplink and a downlink between a base station and an access terminal;

FIG. 3 illustrates some aspects of a protocol stack for a communications system;

FIG. 4 illustrates an example of a buffer status report (BSR) message;

FIG. 5 is a flow chart illustrating an example of a process for mitigating generation of scheduling request (SR) and/or random access channel (RACH) procedures;

FIG. 6 illustrates an example of an access terminal that mitigates generation of RS and/or RACH procedures;

FIG. 7 is a block diagram of an example base station that generates a semi-persistent schedule (SPS) for use by a user terminal; and

FIG. 8 is an illustration of an example system that mitigates generation of RS and/or RACH procedures.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

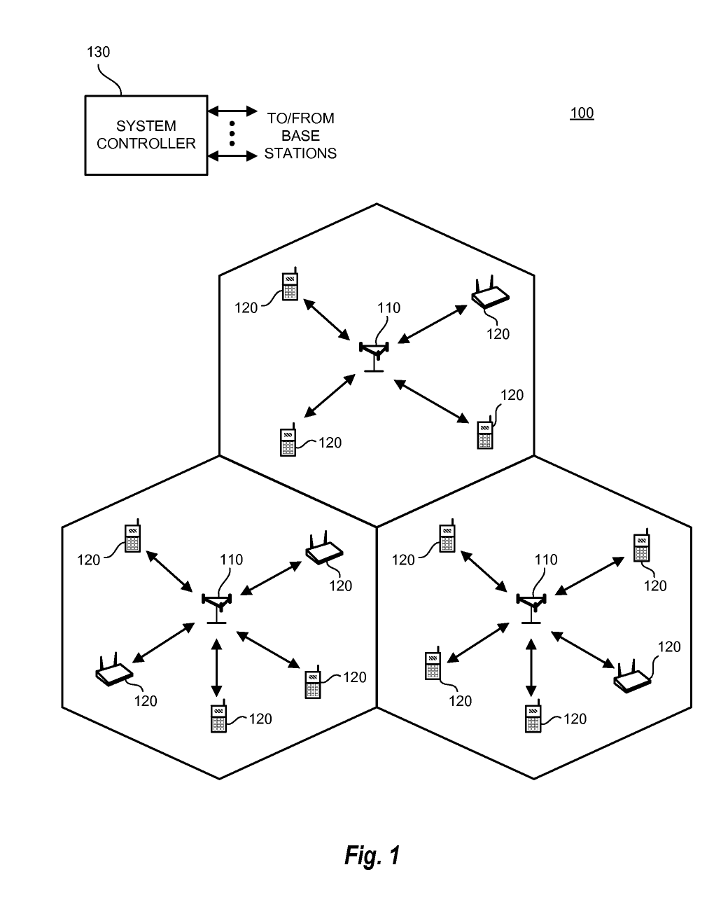

FIG. 1 shows a wireless communication system 100, which may be an LTE network. System 100 may include base stations 110 and other network entities described by 3GPP. A base station may be a fixed station that communicates with the access terminals. Each base station 110 may provide communication coverage for a particular geographic area. To improve network capacity, the overall coverage area of a base station may be partitioned into multiple (e.g., three) smaller areas. Each smaller area may be served by a respective base station subsystem. In 3GPP, the term “cell” can refer to the smallest coverage area of a base station and/or a base station subsystem serving this coverage area.

A system controller 130 may include a mobility management entity (MME) and a serving gateway (S-GW), and may couple to a set of base stations and provide coordination and control for these base stations. S-GW may support data services such as packet data, Voice-over-Internet Protocol (VoIP), video, messaging, etc. MME may be responsible for path switching between a source base station and a target base station at handover. System controller 130 may couple to a core and/or data network (e.g., the Internet) and may communicate with other entities (e.g., remote servers and terminals) coupled to the core/data network.

Access terminals 120 may be dispersed throughout the network, and each access terminal may be stationary or mobile. An access terminal may communicate with a base station via downlink and uplink. The downlink (or forward link) refers to the communication link from the base station to the access terminal, and the uplink (or reverse link) refers to the communication link from the access terminal to the base station. In FIG. 1, a solid line with double arrows indicates active communication between a base station and an access terminal.

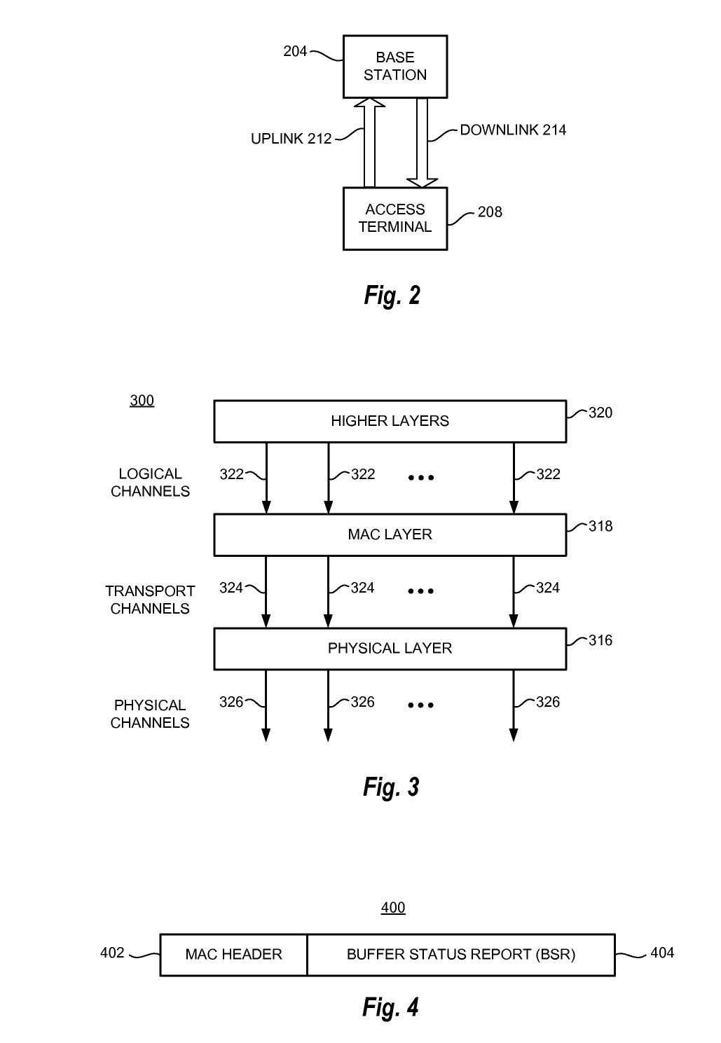

FIG. 2 illustrates an uplink 212 and a downlink 214 between a base station 204 and an access terminal 208. The base station 204 and the access terminal 208 may correspond to the base station 110 and the access terminal 120 shown in FIG. 1. The uplink 212 refers to transmissions from the access terminal 208 to the base station 204; and the downlink 214 refers to transmissions from the base station 204 to the access terminal 208.

FIG. 3 illustrates some aspects of a protocol stack for a communications system. Both, the base station 204 and the access terminal 208 may include the protocol stack 300 illustrated in FIG. 3. The protocol stack may include a physical layer (PHY) 316, a Medium Access Control (MAC) 318, and higher layers 320.

Each protocol receives service data units (SDUs) from a higher sublayer/layer and provides protocol data units (PDUs) to a lower sublayer/layer. For example, the MAC layer 318 receives data from the higher layers 320 via one or more logical channels 322. The higher layers 320 may include packet data convergence protocol (PDCP) and radio link control (RLC).

The MAC layer 318 may perform various functions such as mapping between logical channels 322 and transport channels 324, multiplexing and demultiplexing of various PDUs for logical channels 322 into/from transport blocks for transport channels 324, traffic volume measurement reporting, error correction through hybrid ARQ (HARQ), priority handling between logical channels 322 of an access terminal, priority handling between access terminals via dynamic scheduling, transport format selection, padding, etc. The physical layer 316 offers data transport services via physical channels 326. For example, the access terminal 208 and the base station 204 may communicate via E-UTRA air-link interface at the PHY layer 316.

The MAC layer 318 may provide data transfer services via the logical channels 322. A set of the logical channels 322 may be defined for different data transfer services offered by the MAC layer 318. For example, each of the logical channels 322 may correspond to a specific application, such as voice over IP (VoIP), videotelephony, file transfer protocol (FTP), gaming, etc. The MAC layer 318 may also utilize a set of transport channels 324 to carry data for the logical channels 322. The logical channels 322 may be characterized by what is transported whereas the transport channels 324 may be characterized by how and with what characteristics user data and control data are transferred over a radio interface. The logical channels 322 may be mapped to transport channels 324, which may further be mapped to physical channels 326. Each of the logical channels 322 may also be assigned a different priority level depending on the type of data transfer service it carries. For example, a logical channel carrying VoIP service may be assigned a higher priority than a logical channel carrying FTP service. The data that is ready to be transmitted from the access terminal to the base station is stored in a transmission buffer (not shown) of the corresponding logical channel 322. The access terminal is configured to transmit data on logical channels 322 with higher priority before the data on logical channels 322 with lower priority.

The base station may allocate physical layer resources for the uplink and downlink shared channels (UL-SCH and DL-SCH) by transmitting grants to the access terminal via semi-persistent scheduling (SPS). Allocations may be valid for one or more time transmission intervals (TTI). Each TTI is one subframe (1 ms). SPS allows the base station to set up ongoing allocation that persists until it is changed.

Generally, whenever higher priority data arrives at an access terminal, a regular buffer status report (BSR) is triggered for transmission to a base station. The access terminal transmits the BSR on an uplink to inform an uplink packet scheduler of the base station regarding the amount of buffered data at the access terminal, as well as the priority level of the data. The BSR mechanism typically includes a triggering phase and a reporting phase.

BSR is typically triggered if uplink data arrive in the access terminal transmission buffer and the data belong to a logical channel group with higher priority than those for which data already existed in the access terminal transmission buffer. This also covers the case of new data arriving in an empty buffer. This type of BSR may be referred to as “regular BSR.” Regular BSR may also be triggered when a serving cell change occurs. Other types of BSR, such as “padding BSR” and “periodic BSR,” may also be triggered by different events.

The main uplink buffer status reporting mechanisms are the scheduling request (SR) and the BSR. The SR is typically used to request physical uplink shared channel (PUSCH) resources and is transmitted when a reporting event has been triggered and the access terminal is not scheduled on PUSCH in the current TTI. The SR can be conveyed to the base station in various ways. One way is by using a dedicated one-bit BSR on the physical uplink control channel (PUCCH), when available. The occurrence of SR resources on PUCCH is configured via radio resource control (RRC) on a per access terminal basis. Another way is by using a random access channel procedure (RACH). RACH may be used when neither PUSCH allocation nor SR resources are available on PUCCH. SR is typically only transmitted as a consequence of the triggering of a “regular BSR,” and not the other kinds of BSR.

FIG. 4 is a diagram illustrating an example of a BSR message used in an LTE system. BSRs are transmitted using MAC control element when the access terminal has allocated resources on PUSCH in the current TTI and a reporting event has been triggered. Basically, the BSR is transmitted as a MAC packet data unit (PDU) 400, where the field length is omitted and replaced with buffer status information. The MAC PDU 400 is generated with a MAC header 402 and a MAC service data unit (SDU) 404. The MAC header 402 contains the type and size of the MAC SDU 404.

As described above, trigger of the regular BSR results in triggering of a SR when the access terminal does not have any uplink (UL) resources to transmit the regular BSR. The access terminal would repeatedly transmit the SR to the base station until it receives a grant to transmit the BSR. If the SR is not accepted by the base station, then the access terminal typically executes the RACH procedure, indicating to the base station that it has data to send but does not have a grant to send the data.

As part of semi-persistent scheduling (SPS), the base station can transmit a pre-defined grant to the access terminal with regular intervals to transmit data on the UL, which can be used by the access terminal to transmit data from applications (e.g., VoIP) that generate a known amount of data at regular intervals.

Typically, SPS is valid only during periodic transmission time intervals (TTI). Unfortunately, arrival of data for transmission for the access terminal to the base station will usually not coincide with the SPS TTI. As such, the arrival of data will most likely result in the triggering of regular BSR, which in-turn will trigger SR. If SR is not accepted at the base station, then this will result in the access terminal triggering a spurious RACH procedure, which may be a costly operation from the perspective of the access terminal as well as the base station.

In accordance with aspects of the present disclosure, the access terminal is configured to only trigger regular BSR/SR/RACH only if the amount of data to be transmitted to the base station is greater than the amount accommodated by the SPS grant. If the amount of data to be transmitted is less than or equal to the amount accommodated by the SPS grant, then the access terminal may wait for a subsequent SPS TTI interval to transmit this data instead of triggering regular BSR/SR/RACH.

If the base station deactivates or reduces the SPS grant and there is pending data to be transmitted on the access terminal, then the access terminal may decide to trigger the RACH procedure in order to obtain a grant to transmit the BSR and pending data.

If the SPS grant is active but is less than the amount of data to be transmitted from the access terminal, and if SR is not accepted by the base station, then the access terminal may decide to delay the BSR transmission until a subsequent SPS TTI instead of triggering RACH.

If the amount of data to be transmitted is greater than that accommodated by the SPS grant, the access terminal may decide to trigger SR/RACH in order to obtain a dynamic grant from the base station. In this case, while the base station is not aware of the exact amount of data to be transmitted from the access terminal, the base station is aware that more data than that accommodated by the SPS grant is queued at the access terminal. The base station may then determine that a dynamic grant in addition to the SPS grant is required to accommodate transmission of data with minimum delay.

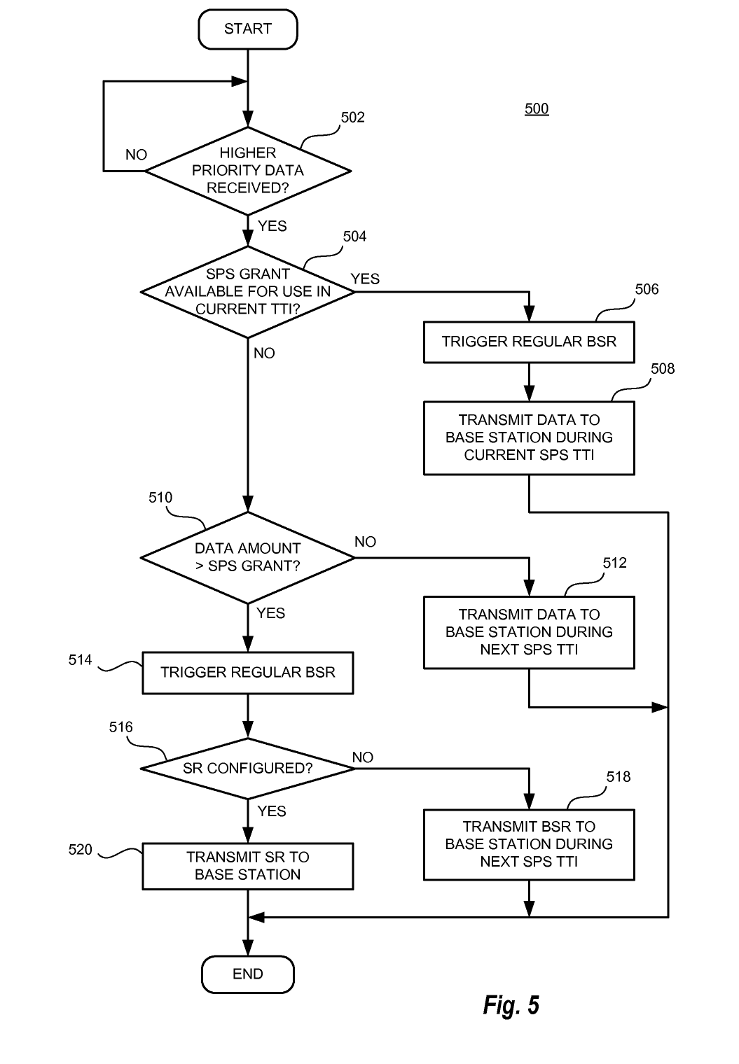

FIG. 5 is a flow chart illustrating an example of a process for mitigating generation of SR and/or RACH procedure. The process may be implemented in the access terminals 120 of system 100. As shown in FIG. 5, in block 502, a determination is made as to whether a higher priority data is received in a buffer of a high priority logic channel. If high priority data is not received, then the process returns to block 502. Otherwise, the process proceeds to block 504. In block 504 a determination is made as to whether an SPS grant is available for use in a current TTI. If an SPS grant is not available, then the process proceeds to block 510. Otherwise, the process proceeds to block 506. In block 506, a regular BSR is triggered, and the process proceeds to block 508. In block 508, the high priority data is transmitted to the base station during the current SPS TTI, and the process ends.

In block 510, a determination is made as to whether an amount of the high priority data is greater than the amount of data that can be accommodated by the SPS grant. If the amount of data is greater than that accommodated by the SPS grant, then the process proceeds to block 514, otherwise the process proceeds to block 512. In block 512, the high priority data is transmitted to the base station during the next SPS TTI, and neither the BSR, SR, nor RACH are triggered. Thereafter, the process ends.

In block 514, regular BSR is triggered, and the process proceeds to block 516. In block 516, a determination is made as to whether the base station is configured to receive SR from the access terminal. If the base station is not configured to receive SR, then the process proceeds to block 518. Otherwise, the process proceeds to block 520. In block 518, BSR is transmitted to the base station during the next SPS TTI, and RACH is not triggered. Thereafter, the process ends. In block 520 the SR is transmitted to the base station, and the process ends.

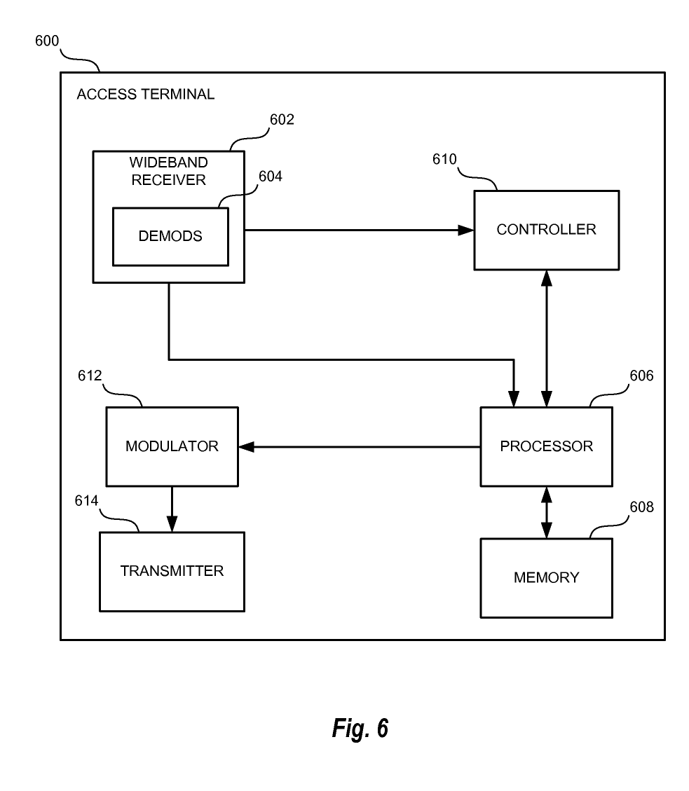

FIG. 6 is an illustration of an access terminal that mitigates triggering of RS and/or RACH procedures. The access terminal 600 may correspond to the one of the access terminals 120 shown in FIG. 1. As shown in FIG. 6, the access terminal 600 may include a receiver 602 that receives multiple signals from, for instance, one or more receive antennas (not shown), performs typical actions on (e.g., filters, amplifies, downconverts, etc.) the received signals, and digitizes the conditioned signals to obtain samples. The receiver 602 may include a plurality of demodulators 604 that can demodulate received symbols from each signal and provide them to a processor 606 for channel estimation, as described herein. The processor 606 can be a processor dedicated to analyzing information received by the receiver 602 and/or generating information for transmission by a transmitter 616, a processor that controls one or more components of the access terminal 600, and/or a processor that both analyzes information received by the receiver 602, generates information for transmission by the transmitter 616, and controls one or more components of the access terminal 600.

The access terminal 600 may additionally include memory 608 that is operatively coupled to the processor 606 and that can store data to be transmitted (e.g., high priority data), received data, information related to available channels, data associated with analyzed signal and/or interference strength, information related to an assigned channel, power, rate, or the like, and any other suitable information for estimating a channel and communicating via the channel. Memory 608 can additionally store protocols and/or algorithms associated with estimating and/or utilizing a channel (e.g., performance based, capacity based, etc.).

It will be appreciated that the data store (e.g., memory 608) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 608 of the subject systems and methods is intended to comprise, without being limited to, these and any other suitable types of memory.

The receiver 602 can further be operatively coupled to a SR/RACH controller 610 that can mitigate the triggering of SR and/or RACH procedures, control the acquisition and storage in memory 608 of the high priority data, and direct communications with the base station by interfacing with transmitter 614 via the processor 606, as discussed with reference to FIG. 1. For example, in accordance with an aspect of the present disclosure, the controller 610 may be the means for receiving data on a logical channel; means for determining that a first grant is not available during a first time transmission interval; means for determining whether to generate at least one of a BSR, a SR, and a RACH procedure based on an amount of the received data; means for determining that a second grant is available during a second time transmission interval; and means for transmitting the received data during the second time transmission interval without generating the BSR, the SR, and the RACH procedure when the amount of the received data is less than or equal to the size of the grant.

The access terminal 600 still further comprises a modulator 612 that modulates and transmits signals via transmitter 614 to, for instance, a base station, a web/internet access point name (APN), and another access terminal, etc. Although depicted as being separate from the processor 606, it is to be appreciated that the SR/RACH controller 610, demodulators 604, and/or modulator 612 can be part of the processor 606 or multiple processors (not shown). Furthermore, the functions of the SR/RACH controller 610 may be integrated in an application layer, a data stack, an HTTP stack, at the operating system (OS) level, in an internet browser application, or in an application specific integrated circuit (ASIC).

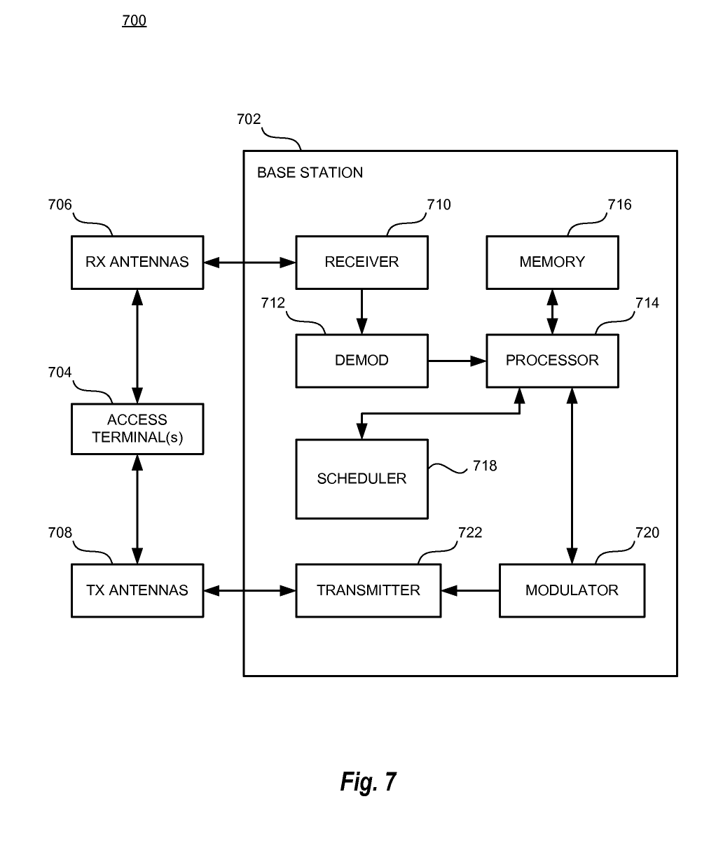

FIG. 7 is an illustration of a system 700 that generates a semi-persistent schedule (SPS) for use by an access terminal. The system 700 comprises a base station 702 (e.g., access point, femtocell, etc.) with a receiver 710 that receives signal(s) from one or more access terminals 704 through a plurality of receive antennas 706, and a transmitter 724 that transmits to the one or more access terminals 704 through a transmit antenna 708. Receiver 710 can receive information from receive antennas 706 and is operatively associated with a demodulator 712 that demodulates received information. Demodulated symbols are analyzed by a processor 714 that can perform some or all functions (e.g., semi-persistent scheduling) for the base station 708 described above with regard to FIG. 1, and which is coupled to a memory 716 that stores information related to estimating a signal (e.g., pilot) strength and/or interference strength, data to be transmitted to or received from mobile device(s) 704 (or a disparate base station (not shown)), and/or any other suitable information related to performing the various actions and functions set forth herein. Processor 714 is further coupled to a scheduler 718 that can generate a SPS for use by the access terminals 704. Although depicted as being separate from the processor 714, it is to be appreciated that the scheduler 718, demodulator 712, and/or modulator 720 can be part of the processor 714 or multiple processors (not shown).

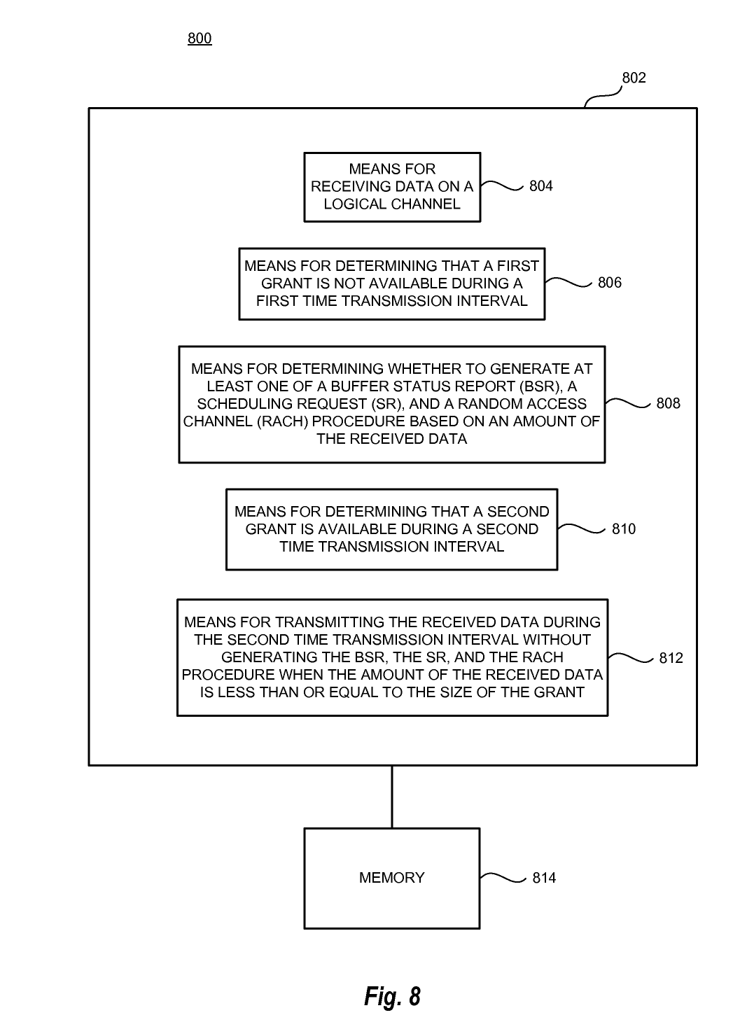

FIG. 8 is an illustration of an example system 800 that mitigates triggering of RS and/or RACH procedures. For example, system 800 can reside at least partially within an access terminal, etc. It is to be appreciated that system 800 is represented as including functional blocks, which can be functional blocks that represent functions implemented by a processor, software, or combination thereof (e.g., firmware). System 800 includes a logical grouping 802 of means that can act in conjunction. For instance, logical grouping 802 can include: means for receiving data on a logical channel 804; means for determining that a first grant is not available during a first time transmission interval 806; means for determining whether to generate at least one of a buffer status report (BSR), a scheduling request (SR), and a random access channel (RACH) procedure based on an amount of the received data 808; means for determining that a second grant is available during a second time transmission interval 810; and means for transmitting the received data during the second time transmission interval without generating the BSR, the SR, and the RACH procedure when the amount of the received data is less than or equal to the size of the grant 812. Additionally, system 800 can include a memory 814 that retains instructions for executing functions associated with the means 804 through 812. While shown as being external to memory 814, it is to be understood that one or more of the means 804 through 812 can exist within memory 814.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A wireless communication apparatus, comprising:
a controller configured to:
receive data on a logical channel;
determine that a first grant is not available during a first time transmission interval;
determine whether to generate at least one of a buffer status report (BSR), a scheduling request (SR), and a random access channel (RACH) procedure based on an amount of the received data;
determine that a second grant is available during a second time transmission interval; and
transmit the received data during the second time transmission interval without generating the BSR, the SR, and the RACH procedure when the amount of the received data is less than or equal to the size of the grant.

2. The wireless communication apparatus of claim 1, wherein each of the first and second grants is a semi-persistent scheduling (SPS) grant.

3. The wireless communication apparatus of claim 2, wherein the controller is further configured to trigger the BSR when the amount of the received data is greater than the size of the SPS grant.

4. The wireless communication apparatus of claim 3, wherein the controller is further configured to determine whether to transmit the SR to a base station based on whether the base station is configured to receive the SR, and transmit the BSR to the base station without triggering the SR and the RACH procedure during the second time transmission interval when the base station is not configured to receive the SR.

5. The wireless communication apparatus of claim 4, wherein the controller is further configured to transmit the SR to the base station when the base station is configured to receive the SR, and receive a third grant for transmission of the data.

6. The wireless communication apparatus of claim 1, wherein the logical channel is designated as having a priority higher than that of other logical channels.

7. The wireless communication apparatus of claim 6, wherein the logical channel is configured to carry voice over Internet protocol (VoIP) data.

8. The wireless communication apparatus of claim 5, wherein the third grant is a type of grant that is different from the first grant and the second grant.

9. The wireless communication apparatus of claim 8, wherein the third grant is a dynamic grant.

10. A method for wireless communication, comprising:
receiving data on a logical channel;
determining that a first grant is not available during a first time transmission interval;
determining whether to generate at least one of a buffer status report (BSR), a scheduling request (SR), and a random access channel (RACH) procedure based on an amount of the received data;
determining that a second grant is available during a second time transmission interval; and
transmitting the received data during the second time transmission interval without generating the BSR, the SR, and the RACH procedure when the amount of the received data is less than or equal to the size of the grant.

11. The method of claim 10, wherein each of the first and second grants is a semi-persistent scheduling (SPS) grant.

12. The method of claim 11, further comprising triggering the BSR when the amount of the received data is greater than the size of the SPS grant.

13. The method of claim 12, further comprising determining whether to transmit the SR to a base station based on whether the base station is configured to receive the SR, and transmitting the BSR to the base station without triggering the SR and the RACH procedure during the second time transmission interval when the base station is not configured to receive the SR.

14. The method of claim 13, further comprising transmitting the SR to the base station when the base station is configured to receive the SR, and receiving a third grant for transmission of the data.

15. The method of claim 10, wherein the logical channel is designated as having a priority higher than that of other logical channels.

16. The method of claim 15, wherein the logical channel is configured to carry voice over Internet protocol (VoIP) data.

17. The method of claim 14, wherein the third grant is a type of grant that is different from the first grant and the second grant.

18. The method of claim 17, wherein the third grant is a dynamic grant.

19. An apparatus comprising:
means for receiving data on a logical channel;
means for determining that a first grant is not available during a first time transmission interval;
means for determining whether to generate at least one of a buffer status report (BSR), a scheduling request (SR), and a random access channel (RACH) procedure based on an amount of the received data;
means for determining that a second grant is available during a second time transmission interval; and
means for transmitting the received data during the second time transmission interval without generating the BSR, the SR, and the RACH procedure when the amount of the received data is less than or equal to the size of the grant.

20. The apparatus of claim 19, wherein each of the first and second grants is a semi-persistent scheduling (SPS) grant.

21. The apparatus of claim 20, further comprising means for triggering the BSR when the amount of the received data is greater than the size of the SPS grant.

22. The apparatus of claim 21, further comprising means for determining whether to transmit the SR to a base station based on whether the base station is configured to receive the SR, and means for transmitting the BSR to the base station without triggering the SR and the RACH procedure during the second time transmission interval when the base station is not configured to receive the SR.

23. The apparatus of claim 22, further comprising means for transmitting the SR to the base station when the base station is configured to receive the SR, and means for receiving a third grant for transmission of the data.

24. The apparatus of claim 19, wherein the logical channel is designated as having a priority higher than that of other logical channels.

25. The apparatus of claim 24, wherein the logical channel is configured to carry voice over Internet protocol (VoIP) data.

26. The apparatus of claim 23, wherein the third grant is a type of grant that is different from the first grant and the second grant.

27. The apparatus of claim 26, wherein the third grant is a dynamic grant.

28. A computer program product, comprising:
a computer-readable medium comprising:
code for receiving data on a logical channel;
code for determining that a first grant is not available during a first time transmission interval;
code for determining whether to generate at least one of a buffer status report (BSR), a scheduling request (SR), and a random access channel (RACH) procedure based on an amount of the received data;
code for determining that a second grant is available during a second time transmission interval; and
code for transmitting the received data during the second time transmission interval without generating the BSR, the SR, and the RACH procedure when the amount of the received data is less than or equal to the size of the grant.

29. The computer program product of claim 28, wherein each of the first and second grants is a semi-persistent scheduling (SPS) grant.

30. The computer program product of claim 29, wherein the computer-readable medium further comprises code for triggering the BSR when the amount of the received data is greater than the size of the SPS grant.

31. The computer program product of claim 30, wherein the computer-readable medium further comprises code for determining whether to transmit the SR to a base station based on whether the base station is configured to receive the SR, and code for transmitting the BSR to the base station without triggering the SR and the RACH procedure during the second time transmission interval when the base station is not configured to receive the SR.

32. The computer program product of claim 31, wherein the computer-readable medium further comprises code for transmitting the SR to the base station when the base station is configured to receive the SR, and code for receiving a third grant for transmission of the data.

33. The computer program product of claim 28, wherein the logical channel is designated as having a priority higher than that of other logical channels.

34. The computer program product of claim 33, wherein the logical channel is configured to carry voice over Internet protocol (VoIP) data.

35. The computer program product of claim 32, wherein the third grant is a type of grant that is different from the first grant and the second grant.

36. The computer program product of claim 35, wherein the third grant is a dynamic grant.
